(19) United States
(12) Patent Application Publication
(10) Pub. No.: US 2023/0410105 A1
(43) Pub. Date: Dec. 21, 2023

(54) Methods and Systems for Transferring Cryptocurrency Between a Plurality of Wallets, Without Revealing an Origin or a Destination or Encrypted, Origin or a Destination

(71) Applicant: Ilya Gazman, Jersey City, NJ (US)

(72) Inventor: Ilya Gazman, Jersey City, NJ (US)

(21) Appl. No.: 18/081,451

(22) Filed: Dec. 14, 2022

Related U.S. Application Data
(63) Continuation-in-part of application No. 16/416,243, filed on May 19, 2019, now abandoned.

(51) Int. Cl. G06Q 20/40; G06Q 20/38; G06Q 20/36

(52) U.S. Cl. CPC G06Q 20/401; G06Q 20/389; G06Q 20/36

(57) ABSTRACT

A system and method for transferring cryptocurrency between a plurality of wallets, without revealing an origin or a destination or encrypted, origin or a destination is disclosed. The system comprises a communications network and a blockchain-network comprising a plurality of computing devices. Each of the plurality of computing devices comprise a processor, a local storage, and a transceiver. Each of the computing devices corresponds with one of a plurality of users, wherein each of the computing devices is configured for sending a plurality of types of transactions and receiving a plurality of blocks based on a plurality of blockchain protocols.

### CROSS-REFERENCE TO RELATED APPLICATIONS

This application claims the benefit of the filing date of U.S. Non-Provisional application Ser. No. 16/416,243 titled “Cryptocurrency with Royal Network, Decentralized Trusted Party and Automated Smart Contracts” and filed May 19, 2019, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of blockchain, and more specifically to the field of transferring cryptocurrency between a plurality of wallets, without revealing an origin or a destination or encrypted, origin or destination, pursuant to specific protocols on the blockchain.

### BACKGROUND

Blocks are data units that store all the information in the cryptocurrency system, such as transactions, smart contracts, and more. Blocks are created based on a consensus algorithm, where Proof of Work (“POF”) is the most common one. In POF, blocks are created using a process called mining Block mining requires solving a hard cryptographical problem of partial hash collisions to mine a new block. Each block has a hash signature of the previous block, and together they form a blockchain.

Today, cryptocurrencies do not support microtransactions because there is a limit to how many transactions per second (“TPS”) can be executed on a blockchain. While Visa® can execute 24,000 TPS, Bitcoin can do 7 TPS, and Ethereum® 20 TPS. Each transaction is publicly broadcast over the blockchain network. Some cryptocurrencies encrypt those transactions, but most do not. Due to the relatively high transaction fee amount, its not possible to purchase low-cost products as the fee itself can sometimes go over $10. The amount can be smaller in nonpopular cryptocurrencies, but there is no promise it will stay that way.

Today, trusted parties and cryptocurrency decentralization are considered to be opposites. Additionally, there is no solution to allow government regulators to protect cryptocurrency users from illegal trades and fraudulent activity. There is no way to make transactions and wallet owners to be visible for governments regulators but not publicly available for everyone.

As a result, there exists a need for improvements over the prior art and more particularly for a more efficient way of transferring cryptocurrency between a plurality of wallets, without revealing an origin or a destination or encrypted, origin or a destination.

### SUMMARY

A system and method for transferring cryptocurrency between a plurality of wallets, without revealing an origin or a destination or encrypted, origin or a destination is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a system for transferring cryptocurrency between a plurality of wallets, without revealing an origin or a destination or encrypted, origin or a destination is disclosed. The system comprises a communications network and a blockchain-network comprising a plurality of computing devices. Each of the plurality of computing devices comprise a processor, a local storage, and a transceiver. Each of the computing devices corresponds with one of a plurality of users, wherein each of the computing devices is configured for sending a plurality of types of transactions and receiving a plurality of blocks based on a plurality of blockchain protocols. The processor and the receiver for each computing device of the plurality of computing devices is configured for generating, using the processor of a first computing device of one of the plurality of computing devices, a user wallet, wherein the user wallet comprises a private key and a wallet address. Then, the system stores, in the local storage of the first computing device, the user wallet; validating, with the processor, the plurality of blocks to be added to a blockchain associated with the blockchain network, by executing the plurality of blockchain protocols; storing, in the local storage of the first computing device, the blockchain comprising the plurality of blocks.

The system improves over the prior art by generating, with the processor, a first type of transaction comprising a wallet address of the user wallet, a second wallet address of a DTP wallet of the DTP user, an update time defined by a predetermined periodic execution for a second type of transaction, and a signature generated using the private key of the user wallet. After the first type of transaction is generated, then sending the first type of transaction over the communications network to the blockchain network to: cancel prior wallet authorizations to prior DTP users; and grant a wallet authorization to the DTP user to transact the user wallet upon the execution of the second type of transaction. Granting of the wallet authorization and cancelling of prior wallet authorizations is executed when the first type of transaction is added to the blockchain-network and one of (i) a prior DTP user, authorized to transact the user wallet based on a prior first type of transaction, executes the second type of transaction, (ii) the prior DTP user fails to execute the second type of transaction within the update time of the prior first type of transaction.

The system determines that the wallet address of the user wallet is not associated with any prior first types of transactions and prohibits the private key of the user wallet from generating a block signature for any type of transaction other than a second first type of transaction and the third type of transaction, until the DTP user fails to execute the second type of transaction within the update time; receiving a block over the communications network with the receiver comprising the second type of transaction.

The second type of transaction comprises: the second wallet address of the DTP wallet of the DTP user; a plurality of second user wallets associated a plurality of second users; the wallet address of the user wallet associated with the first user; an updated balance for each wallet address in the second type of transaction; and a second signature generated using the second private key of the DTP wallet of the DTP user. After receiving the block, then validating the block by executing a plurality of blockchain protocols comprising: determining that the second type of transaction was executed within the update time specified by the first type of transaction; determining that a second user second type of transaction was executed within the second user update time specified by a plurality of second user first type of transactions; determining whether any of the wallet addresses in the second type of transaction are associated with at least one of (1) the second first type of transaction and (2) the third type of transaction; determining whether a total balance of the wallets in the second type of transaction is unaltered; if the block is validated, then, storing the block on the first computing device and adding the block to a local blockchain of the first computing device; generating, with the processor, the third type of transaction comprising: the wallet address of the user wallet; a third signature generated using the private key of the user wallet; sending the third type of transaction over the communications network to the blockchain network to cancel the wallet authorization for the DTP user after the DTP user executes the second type of transaction and, after cancelling the wallet authorization, then permitting the user to use the user wallet for any type of transaction over the blockchain network.

The predetermined periodic execution and/or update time is one of (i) a predetermined block count, and (ii) a period of time to complete the second type of transaction, wherein the predetermined periodic execution and/or update time starts when at least one of (i) the first type of transaction is sent to the blockchain and (ii) the second type of transaction is validated. The update time continuously restarts after each second type of transaction is validated and ends when the third type of transaction is added to the blockchain network. The update balance of the second type of transaction is determined based on a plurality of intermittent transactions by the DTP user that were executed off of the blockchain network between the user wallet and at least one second user wallet of the plurality of second user wallets. The update balance of the second type of transaction is determined based on a plurality of intermittent transactions by the DTP user between the user wallet and at least one second user wallet of the plurality of second user wallets. The total balance of all the wallets in the second type of transaction is unaltered such that the total balance in the second type of transaction is equal to a first balance of a plurality of first types of transactions. Determining that the wallet address of the user wallet is not associated with any prior first types of transactions comprises at least one of determining that the user has never generated the first type of transaction and determining that the wallet address of the user wallet has generated the first type of transaction and has not generated the third type of transaction. The update time is generated when the DTP wallet is created by the DTP user.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1A is a diagram of an operating environment that supports a system for transferring cryptocurrency between a plurality of wallets, without revealing an origin or a destination or encrypted, origin or a destination, according to an example embodiment;

FIG. 1B is a schematic illustrating communication between the entities in FIG. 1 in relation to transferring cryptocurrency between a plurality of wallets, without revealing an origin or a destination or encrypted, origin or a destination, according to an example embodiment;

FIG. 2A is a diagram of a first user wallet, according to an example embodiment;

FIG. 2B is a diagram of a DTP user wallet, according to an example embodiment;

FIG. 2C is a diagram of a second user wallet, according to an example embodiment;

FIG. 3A is a block diagram of a first type of transaction, according to an example embodiment;

FIG. 3B is a block diagram of a second type of transaction, according to an example embodiment;

FIG. 3C is a block diagram of a third type of transaction, according to an example embodiment;

FIG. 3D is a block diagram of the blockchain pertaining to different types of transactions, according to an example embodiment;

FIG. 3E is a block diagram of the blockchain network pertaining to the first type of transaction, according to an example embodiment;

FIG. 4 is a diagram illustrating steps for a method of providing the system for transferring cryptocurrency between a plurality of wallets, without revealing an origin or a destination or encrypted, origin or a destination, according to an example embodiment.

FIG. 5 is a diagram illustrating steps for a method of generating a user wallet, according to an example embodiment.

FIG. 6A is a diagram illustrating steps for a method of generating the first type of transaction, according to an example embodiment.

FIG. 6B is a diagram illustrating steps for a method of validating the first type of transaction to the blockchain, according to an example embodiment.

FIG. 7 is a diagram illustrating steps for a method of receiving and validating the second type of transaction, according to an example embodiment.

FIG. 8 is a diagram illustrating steps for a method of generating and validating the third type of transaction, according to an example embodiment.

FIG. 9 is a block diagram of a system including a computing device and other computing devices, according to an exemplary embodiment of present technology.

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing methods and systems for transferring cryptocurrency between a plurality of users without revealing an origin or a destination, or an encrypted origin or an encrypted destination. When a user wants to transact cryptocurrency with a plurality of second users, the user allows a decentralized trusted party, “DTP user” to perform update transactions on the user's behalf such that the transactions are not publicly shared, included in encrypted form. The update transactions are resulting balances in the user wallet based on off-chain transactions, thus, the recorded transaction on the blockchain does not reveal an origin or destination of transactions. There could be unlimited number of transactions between the first and the second users before their balance is updated on the blockchain that is visible publicly or in encrypted form as record in the update transaction. The present disclosure significantly increases the number of transactions per second and reduces the transactions fees to allow for microtransactions. Transaction fees are usually calculated based on the byte amount (or fuel in other embodiments with smart contracts). Instead of recording every single transaction between the users onto the blockchain, the DTP user records only the resulting balance that is an aggregate of multiple off-chain transactions. Therefore, the aggregated transaction decreases fees since there is one only one transaction added to the blockchain for a multitude of transactions. Users within the system have more privacy because the update transaction does not include a chain of transactions (i.e., what wallet transacts with which wallet). The blockchain only records an updated balance after a period of time. The updated balance is public so other users can detect fraudulent transactions from the DTP user. The transaction speed is also faster because off chain transaction do not have the speed limitations that exist on the blockchain.

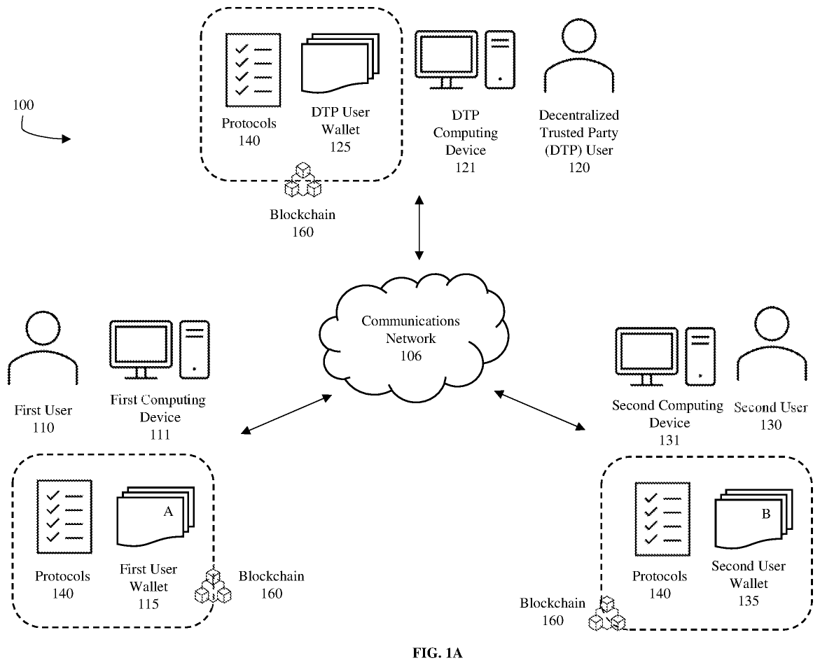

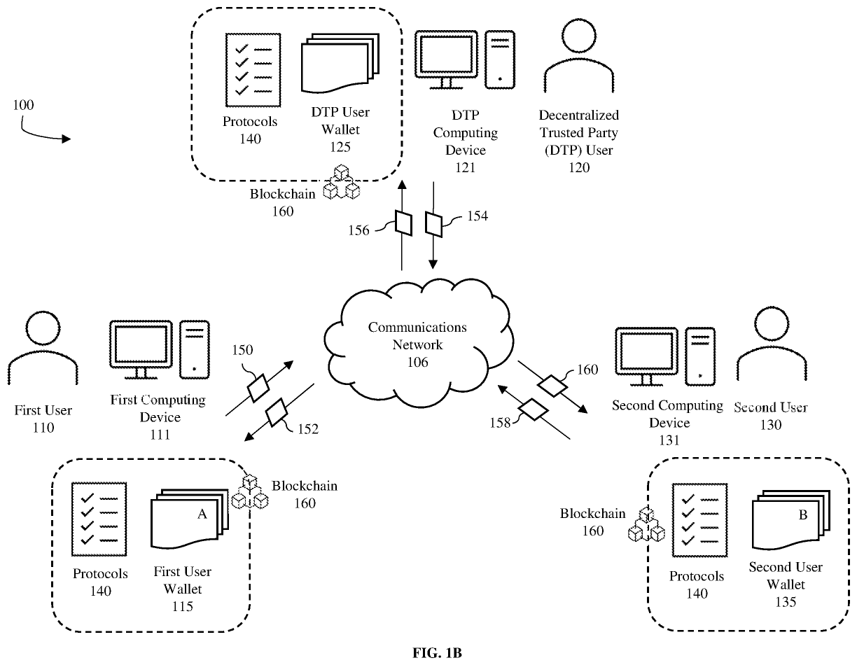

Referring now to the Figures, FIG. 1A is a diagram of an operating environment that supports a system for transferring cryptocurrency between a plurality of wallets, without revealing an origin or a destination or encrypted, origin or a destination in accordance with the principles of the present invention, according to an example embodiment. The most prominent element of FIG. 1 is the blockchain 160 associated with each of a plurality of computing devices coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. In one embodiment, network 106 is a secure network wherein communications between endpoints are encrypted so as to ensure the security of the data being transmitted. The plurality of computing devices includes at least a first computing device 111, a second computing device 131, and a decentralized trusted party (“DTP”) computing device 121.

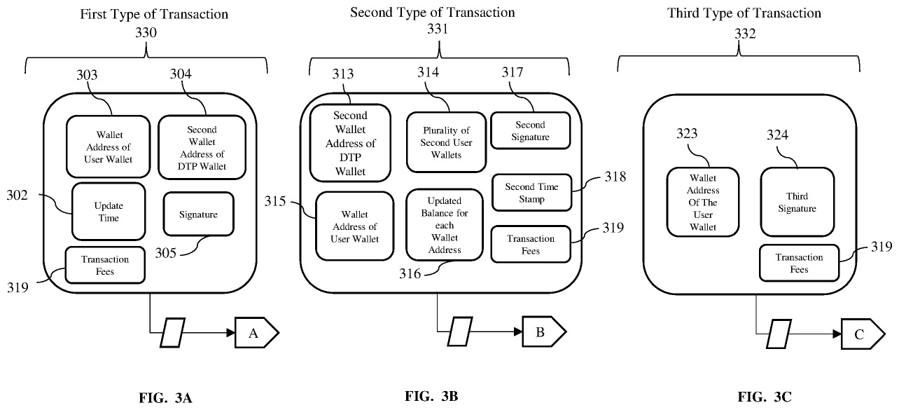

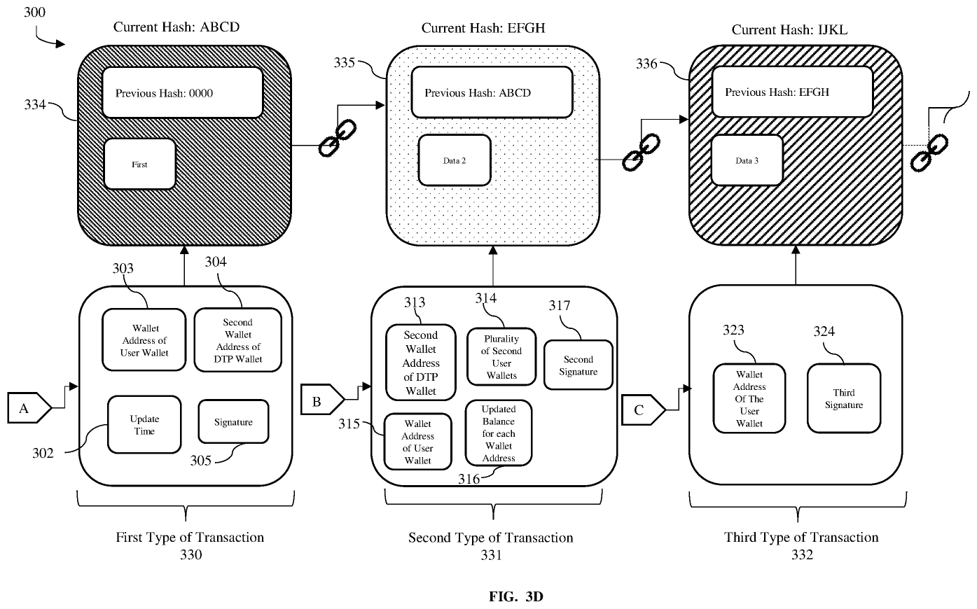

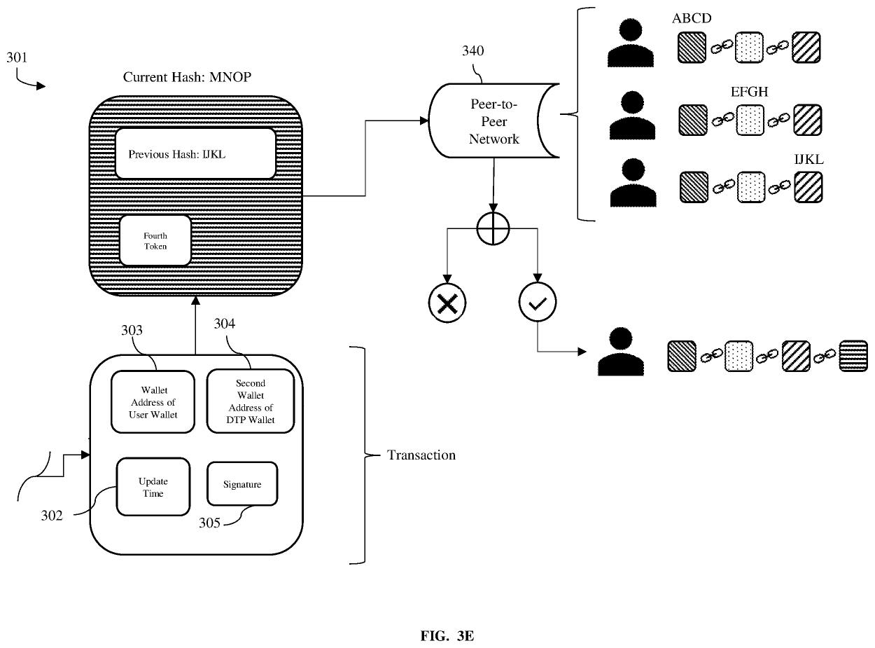

The networked environment may also include a blockchain system or blockchain network for storing one or more distributed ledgers 160 that records transactions, such as, but not limited to, the first type of transaction, the second type of transaction, and third type of transaction (see FIGS. 3A through 3C). Each computing device includes a blockchain 160 and constitutes a node within the blockchain network. The transactions are bundled into blocks and every block (except for the first block) refers to or is linked to a prior block in the chain. Computer nodes may maintain the blockchain and cryptographically validate each new block via blockchain protocols and thus the transactions contained in the corresponding block. A ledger is a record-keeping system that maintains a wallets respective cryptocurrency balance(s).

Users of the block chain create transactions that are broadcast to all of the nodes of the block chain. It is understood that the broadcasted transactions may include encryption. A genuine or “valid” transaction is one that can be validated based on a set of rules or blockchain protocols that are defined by the particular system implementing the block chain. In some POW block chain systems, miners are incentivized to create blocks by a rewards structure that offers a pre-defined per-block reward and/or fees offered within the transactions validated themselves. Thus, when a miner successfully validates a transaction on the block chain, the miner may receive rewards and/or fees as an incentive to continue creating new blocks.

FIG. 1 further includes the first computing device 111, the second computing device 131, and the DTP computing device 121, which each may be smart phones, mobile phones, tablet computers, handheld computers, laptops, or the like. The first computing device 111 corresponds to the first user 110. The second computing device 131 corresponds to the second user 130. The DTP computing device 121 corresponds to the DTP user 120. Each of the computing devices may include a user interface and/or graphical user interface. In certain embodiments, the system may communicate between the first user, the second user, and the DTP user, over the communications network 106, where the first user and second user are separate parties conducting transactions within a DTP group. The system includes a plurality of DTP groups that are nodes of the blockchain network. Each DTP group includes at least one DTP user, a first user, and a plurality of second users. The second users are first users with the same DTP group as the first user. The DTP group is a group of users that entrusted their wallets to the DTP user based on the blockchain protocols and allow the DTP user to update their wallet balance via the second type of transaction based on the blockchain protocols. Typically, the DTP user will be a genuine company with its own monetary system that will allow the DTP group users to perform off-chain transactions between them self and predict their wallet balance after the DTP user performs the second type of transaction.

The DTP user is a decentralized trusted party that performs transactions on the first user's behalf. Generally, trusted parties are considered centralized and, therefore, opposite to the decentralized principle of cryptocurrencies. However, the DTP user is a combination of decentralization and trusted parties. The DTP user is a regular user that is entrusted with other user wallets via the first type of transaction to update their balance during the second type of transaction. In some embodiments, the DTP may be an entity. For example, PayPal® may be a DTP user. PayPal® may share it's DTP wallet address (required for entrusting) with its users and allow them to entrust PayPal® with their wallets. From this point, users will make their transactions via PayPal®; however, PayPal® will not instantly perform a transaction over the blockchain. PayPal® will save each transaction, and, after a predetermined amount of time, it will aggregate all the transactions and make the second type of transaction (update transaction) over the blockchain.

An outside observer will not be able to tell how the coins were exchanged between the users of PayPal®, not even if the observer had access to all the private keys of all the users. This gives users more privacy compared to direct transactions over the blockchain. PayPal® however will be aware of all the transactions between the PayPal® users, and it will report the transactions to the government authorities that will provide law protection for the PayPal® users. When the first user decides to get out of PayPal® by reclaiming ownership on the first user wallet, the first user sends a third type of transaction reclaiming ownership of the first user wallet, and PayPal® will not be able to prevent it. If PayPal® will ever commit a crime by moving the first user coins without the first user consent, the first user will be able to see it by looking into the public blockchain ledger and take legal actions against PayPal®.

Because the DTP user can manage the transactions for the first users and the second users in its internal monetary system, its possible to charge the fees from the seller, rather than the buyer, in a similar way that today's credit cards do. The DTP user doesn't need banks to hold the actual cryptocurrency (“coins”). The blockchain network owns the coins so that the DTP user can enjoy more independence. At any point in time, DTP user does not hold the first users' or second users' coins; therefore, if the DTP user will try to commit some sort of fraudulent activity, the first users and the second users will be able to spot the fraudulent activity right away as any transaction in real coins is made using the blockchain network and is visible to every user. Because the DTP user manages other users' coins, it must allow the government agencies to regulate all the transactions made through it. Therefore, government agencies can protect the users from illegal trades and fraudulent activity. Unlike the transactions made over the blockchain network, the internal transactions made with the DTP user are not publicly broadcast the transactions, so the DTP user provides more privacy to all the users in the DTP; therefore, transactions made with the DTP user do not reveal the origin nor the destination of the transaction in the system, not even in encrypted form.

FIG. 1A shows an embodiment wherein networked computing devices 111, 121, and 131 may interact with other computing devices over the network 106. computing devices 111, 121, and 131 includes a software engine that delivers applications, data, program code and other information to each other. The software engine of computing devices 111, 121, and 131 may perform other processes such as audio and/or video streaming or other standards for transferring multimedia data in a stream of packets that are interpreted and rendered by a software application as the packets arrive. It should be noted that although FIG. 1A shows only three networked mobile computing devices 111, 121, 131, the system of the present invention supports any number of networked mobile computing devices connected via network 106, having at least the first computing device 111, the second computing device 131, and the DTP computing device 121.

The computing devices 111, 121, 131 also include program logic comprising computer source code, scripting language code or interpreted language code that is compiled to produce executable file or computer instructions that perform various functions of the present invention. In another embodiment, the program logic may be distributed among more than one of computing devices 111, 121, 131, or any combination of the above. While the blockchain is illustrated as a single entity, the blockchain is a network with a plurality of other computing devices that independently manage their own copy of the entire blockchain.

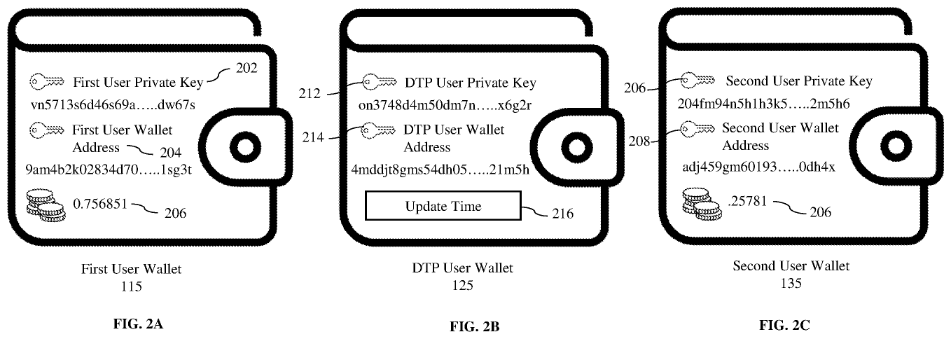

Referring now to FIGS. 2A through 2C, example embodiments of user wallets are illustrated. Wallet encryption, to generate the wallet address and the private key for each user, may be executed using Curve25519. Other wallet encryptions may be used and are within the spirit and scope of the present invention. Curve25519 improves over the prior art by providing a quick processing speed and small signature size, only 64 bytes. The Curve25519 public key for a user is the user's wallet address. Curve25519 is used in elliptic-curve cryptography (“ECC”) and for the elliptic curve Diffie-Hellman (“ECDH”) key agreement scheme. In other embodiments, the blockchain network may use other public key and private key encryption methods such as Rivest-Shamir-Adleman (“RSA”) encryption. The first user wallet 115 includes a first user private key 202 and a first user wallet address 204. The second user wallet 135 includes a second user private key 206 and a second user wallet address 208. The DTP user wallet 125 includes a DTP user private key 212 and a DTP user wallet address 214. The first user wallet and the second user wallet also include a total balance 206 that is calculated from the ledger and represents the amount of currency in the respective wallet. The DTP user wallet may include an update time 216 instead of putting it in the second type of transaction.

When a new wallet address appears in a block for the first time, it is mapped to a consecutive multibyte integer starting from a small, predefined number (ideally, 1). So, when wallets make trust transactions, their address are being mapped. During the update transaction, only the multibyte integers are used since each wallet must have already been mapped in the trust transaction. The DTP users may pay transaction fees when executing the second type of transaction. The DTP user may choose to charge those fees from the internal transactions in its monetary system. Typically, the transaction fee is going to be approximately minimal compared to fees for recording direct transactions over the blockchain. The DTP user, ideally being a legal entity or financial institution, may implement its internal transaction fee policies when aggregating the off-blockchain microtransaction to record in the second type of transaction (the update transaction). This system improves over the prior art by not only reducing blockchain based transaction fees, but rather recording end-transaction balances without revealing an origin or destination, or encrypted origin or destination.

Referring now to FIGS. 3A through 3C, block diagrams of the data in each type of transaction in the system 100 is shown, according to an example embodiment. A first type of transaction 330 includes a wallet address of the user wallet 303, a second wallet address of a DTP wallet 304 of the DTP user, an update time 302, a signature 305 generated using the private key of the user wallet. The first type of transaction is generated by a first user, who sends to the blockchain. The first type of transaction acts as a trust transaction that allows the DTP user to perform transactions on behalf of the first user. However, the DTP user does not receive the private key of the first user wallet. The update time is defined by a predetermined periodic execution of a second type of transaction. The update time is one of a predetermined block count and a period of time to complete the second type of transaction. The update time starts when the first type of transaction is added to the blockchain and resets when the second type of transaction is added to the blockchain. The reset applies for the entire DTP group, even if it doesn't include all the DTP group wallets addresses. For example, the update time may be ten days such that the second type of transaction occurs every ten days or every ten blocks. The update time continuously restarts after each second type of transaction is added to the blockchain. The update time could use the block creation time or the transaction creation time or another timestamp on the blockchain. The update time stops to restart after the third type of transaction is added to the blockchain for the first user. The DTP user may update the first user coins one more time after the first user sends the third type of transaction. This is in order to prevent a race condition between internal and blockchain transactions of the DTP user.

The second type of transaction 331 includes the second wallet address of the DTP wallet 313 of the DTP user, a plurality of second user wallets 314 associated a plurality of second users, the wallet address 315 of the user wallet associated with the first user, an updated balance 316 for each wallet address in the second type of transaction, and a second signature 317 generated using the second private key of the DTP wallet of the DTP user. The second type of transaction may also include a second type stamp 318 and transaction fees 319. The second type of transaction is generated by the DTP user, who sends the second type of transaction to the first user and the second users that the first user has transacted with. The second type of transaction is an update transaction that updates the balances for the first user and the second users. The updated balance of the second type of transaction is determined based on a DTP internal policy. For example, the updated balance may be determined based on a plurality of intermittent transactions that were executed off of the blockchain network between the user wallet and a second user wallet of the plurality of second user wallets. The total balance of all the wallets in the second type of transaction is unaltered such that the total balance in the second type of transaction remains the same after its execution. There is not requirement to update the first user balance or include the first user wallet address in each of the second type of transaction.

The update transaction is a unique transaction that may only be performed by a DTP user. The update transaction updates the balance of multiple wallets in the system. To perform the update transaction, the DTP user is only required to provide its signature and just needs to provide a wallet address and the new balance for each wallet it updates. When miners validate this transaction, they will check that the total number of coins in the system didn't change, meaning that the update transaction only moved coins between the wallets in the transaction, yet no coins were lost, and no coins were gained.

Generally, in the prior art, the transaction fees are calculated based on transaction size in bytes. More bytes in a transaction generate higher transactions fees. Fewer bytes in a transaction generate lower transaction fees. Transaction fees may also include mining fees, gas fees, or minting fees. The present invention improves over the prior art by only recording an aggregate of multiple off-chain transactions, which causes fewer transactions being added to the blockchain. Therefore, there are fewer fees as fewer transactions are recorded to the block chain. There is no requirement to update the first user balance or include the first user wallet address in each of the second type of the transactions.

A third type of transaction 332 includes the wallet address 323 of the user wallet and a third signature 324 generated using the private key of the user wallet. The third type of transaction, which is a termination transaction, is generated by the first user, who sends the third type of transaction to the DTP user to terminate the DTP user's ability to perform transactions on behalf of the first user.

Referring now to FIG. 3D, a block diagram of the blockchain formation pertaining to different types of transactions between the plurality of users is shown, according to an example embodiment. When the first user attempts to transact cryptocurrency with a second user, the computing device of the first user sends a first type of transaction to the blockchain network. Each of the blocks illustrated in FIG. 3D illustrate a type of transaction added to the blockchain. As illustrated in FIG. 3D, each of the blocks includes data corresponding to at least one type of transaction.

In some embodiments, base types of block encoding may include multibyte integers or multibyte floating point. Multibyte integers (“MI”) are at most 4 bytes of data in a big-endian format, wherein the first 2 bits of the first byte are used to represent the byte length of the integer. Multibyte floating points are numbers in a range of 0-10.73741823 inclusive. Those numbers are multiplied by 100,000,000, rounded using a floor function and encoded into at most 4 bytes similar to multibyte integers as described above. In some embodiments, the hash is 32 bytes and computed using SHA-256. The signatures are 64 bytes and computed using Curve25519.

The table below shows examples of MI Ranges:

| 2 bits | Byte | |
|---|---|---|
| encoding | length | Values range |
| 00 | 1 | 0-64 |
| 01 | 2 | 64-16,384 |
| 10 | 3 | 16,384-4,194,304 |
| 11 | 4 | 4,194,304-1,073,741,824 |

The block structure may include headers, lists, and footers. The header structure may include (i) Block id such as Incremental MI value starting from 94. The block includes core version UUID that is 16 bytes universally unique integer. Pool domain address is a domain byte length MI or UTF-8 formatted domain address. Transaction fees are 8 bytes floating point value of the total transaction fees. Smart contract fees are 8 bytes floating point value of the total smart contract fees. Reward is MI block reward and includes a reward id in MI, the wallet id to where 99% of the Reward, transaction fees, and smart contract fees will be sent, Leadership reward id—MI, the wallet id of the leadership organization where 1% of the block reward will be sent, Smart contract execution Hash, Previous block Hash of the previous block

The footer may include a job ID that is 16 bytes. The job ID is a blob value that the pool generates to prevent mining collisions between the miners of the pool. The footer includes a mined date that is an 8-byte integer with milliseconds epoch time. The blob is 8 bytes or random data that the miners use to manipulate the block hash. The block hash is the solution to the hash collision problem within the block difficulty.

Each list includes a MI list type, an MI block id, 1 byte feature bitmask, and the number of items in the list. The list types may be 1 to 1 transaction, 1 to many transactions with the same balance, 1 to many transactions with different balance, smart contracts, smart contracts applications, trusts, the DTP balance update, the list group, and the addresses list. The list may include microtransaction, default transaction fee, and trusted signature. If the microtransaction feature is “on”, the coin transactions amount will be encoded with MFP. If it is “off”, the amount will be 8 bytes floating point. If the default transaction fee is “on”, the transaction fees will be a hardcoded value and will not appear in the transaction. If it is “off”, the transaction fees will be encoded with the list. If trusted signature is “on”, the signature will be omitted. However, this is only valid in the lists group.

A 1 to 1 transaction includes a sender signature, a sender id in MI, a receiver id in MI, an amount as specified in the feature bitmask, and transaction fees as specified in the feature bitmask. A 1 to many transactions with same balance includes the sender signature, sender id in MI, a receivers count in MI, receivers, receiver id in MI, the amount as specified in the feature bitmask, and transaction fees as specified in the feature bitmask. A 1 to many transactions with different balance includes the sender signature, the sender id in MI. the receivers count in MI, receivers, the receiver id in MI, the amount, and transaction fees as specified in the feature bitmask. An Automated Smart Contacts creation includes a creator id that is the MI wallet id of the contract creator, a model data size that is MI model data byte size, model data that is model data size bytes, a script size that is MI script size, script that is MI script size bytes, and a creator signature. An Automated Smart Contacts copy creation includes the creator id that MI wallet id of the contract creator and an Automated Smart Contracts Id that is the MI creator signature. Trusts includes the sender id in MI, DTP wallet id in MI, and a termination hours time in MI. The termination hours time is a value of zero that indicates to start termination based on the sender signature. The DTP balance update includes a DTP id in MI, a plurality of updates that each includes an id in MI and a balance as specified in the feature bitmask, and a DTP signature. The List Group includes a DTP id, lists from the lists previously described, and a DTP signature. The addresses list includes public key wallet addresses. An update transaction of one wallet that made an unlimited amount of transactions by itself will take between 3.8 to 11.4 MB of space per block, which is significantly smaller compared to other cryptocurrency systems.

Referring to FIG. 3E, the most recent block is illustrated being validated by a peer-to-peer network 340. In this example, the most recent block is the first type of transaction. Once the block is validated and stored on the blockchain, each of the updated balances corresponding to the users of the transaction is stored on the computing devices. The peer-to-peer network can be used for communication between nodes such that the nodes may share transactions and blocks.

The process for transferring cryptocurrency between a plurality of wallets, without revealing an origin or a destination or encrypted, origin or a destination over a communications network will now be described with reference to FIGS. 1B and 4 through 8. FIGS. 1B and 4 through 8 depict, among other things, data flow and control flow in the process for transferring cryptocurrency between a first user and a second user, without revealing an origin or a destination or encrypted, origin or a destination over a communications network 106, according to one embodiment. It is understood that in FIG. 1B, the data packets 150, 152, 154, 156, 158, and 160 are used to show the transmission of data and may be used at different stages of the process and are within the spirit and scope of the present invention.

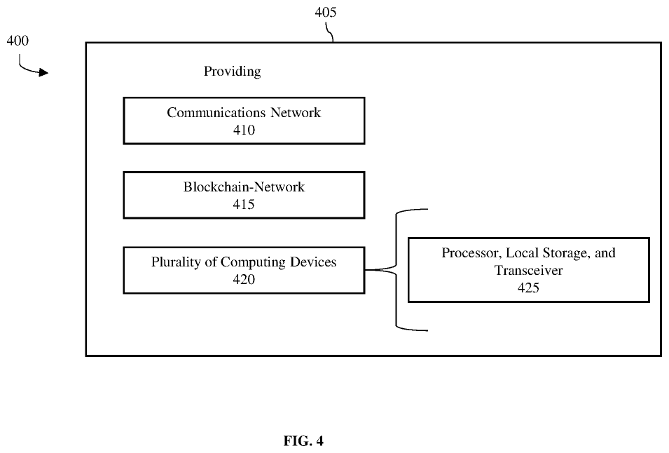

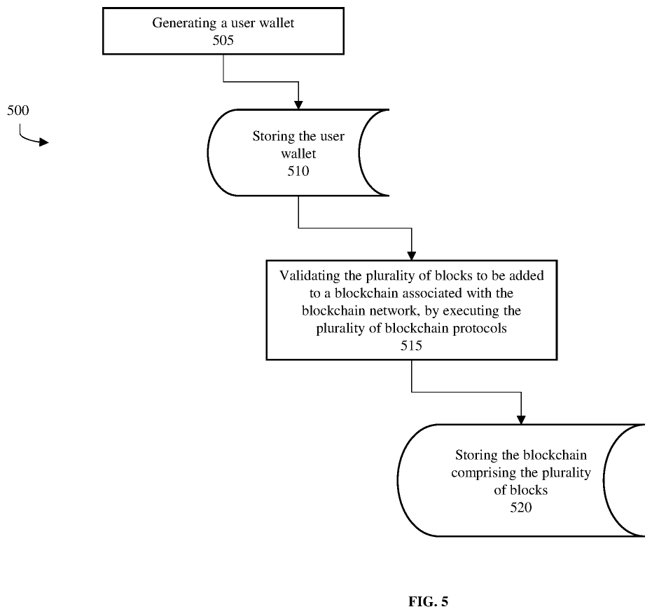

With reference to FIG. 4, the process of the disclosed embodiments begins with step 405 (see block diagram 400), which includes providing the system for transferring cryptocurrency between a plurality of wallets, without revealing an origin or a destination or encrypted, origin or a destination. Providing the system 405 includes providing the communications network 410, providing the blockchain network 415, and providing the plurality of computing devices 420. In step 425, providing each of the plurality of computing devices includes providing at least one processor, a local storage, and a transceiver for each of the computing devices. Each of plurality of computing devices corresponds to a plurality of user and includes a blockchain such that the plurality of computing devices creates a blockchain network. Each of the computing devices are configured for sending a plurality of types of transactions and receiving a plurality of blocks based on a plurality of blockchain protocols 140.

In some embodiments, the blockchain protocols may include a plurality of automated smart contracts. The automated smart contracts offer several benefits over the traditional cryptocurrency smart contracts. The automated smart contracts can be triggered by time, like cron jobs in Linux, and by incoming transactions, thereby making providing the ability to implement subscription services and third-party fee systems.

The automated smart contracts include a model and a script. The model is a modifiable data submitted along with the automated smart contract, and the script is invoked by the nodes of the blockchain network each time the smart contract is executed. When an automated smart contract is executed, it can read and write its model data, read blockchain data, and move coins from the wallet that created it to any other wallet. The automated smart contracts are executed when new blocks are mined. Wallets can create an unlimited number of automated smart contracts. Also, wallets can create an automated smart contract as a copy of existent automate smart contract. It allows reducing the size of the block for those requests.

For example, a game admin creates an automated smart contract that upon execution moves coins (game subscription fee) from the wallet who created the smart contract to the game admin wallet only if its the first of the month and no payment for this month have been made. A user subscribes to the game by creating a copy of that automated smart contract. The game admin sees the user automated smart contract in the blockchain and gives her access to the game. Now every first of the month, the user will be charged with the game subscription fees. Those fees are automatically charged and don't consume additional block space. At some point in the future, the user deactivates her smart contract, the game admin sees that in the blockchain and revoke her access to the game.

As another example, Clark and Lois open an ice cream business where they split their earnings evenly 50/50. Clark creates an automated contract that sends 50% from every incoming transaction to Lois's wallet. So, each time a customer makes a purchase and sends a coin transaction to Clark's wallet, 50% of the costumer's coins are sent to Lois's wallet.

Referring now to FIG. 5, a diagram 500 illustrating steps for a method of generating a user wallet is shown, according to an example embodiment. The method begins with step 505, wherein the processor of a computing device generates a user wallet 505 corresponding the user associated with the computing. The user wallet includes a private key and a wallet address. The wallet is encrypted using Curve25519, as previously described with reference to FIGS. 2A through 2C. In step 510, the processor stores the user wallet in the local storage of the first computing device. In step 515, the processor validates the plurality of blocks to be added to a blockchain associated with the blockchain network by executing the plurality of blockchain protocol. In step 520, the processor stores the blockchain including the plurality of blocks into the local storage of the first computing device.

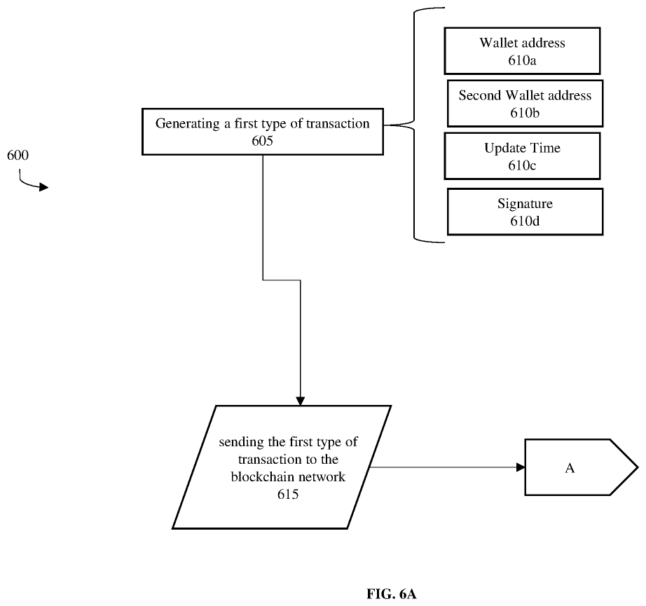

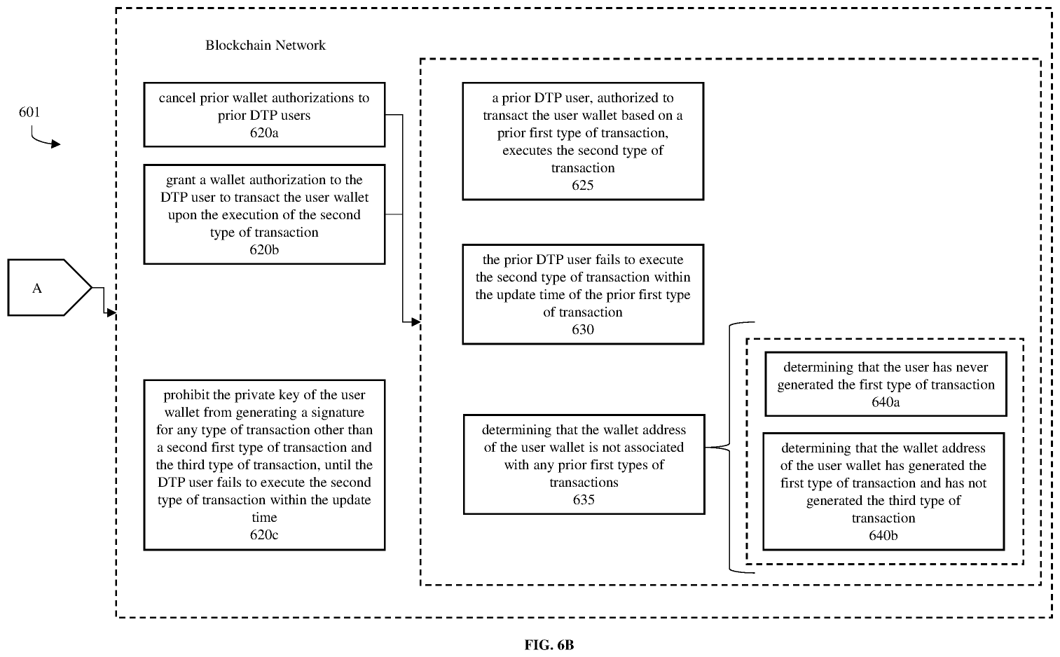

Referring now to FIG. 6A, a diagram 600 illustrating steps for a method of sending a first type of transaction is shown, according to an example embodiment. In the present embodiment, the first user 110 may want to transact cryptocurrency with any of the second users 130 in the same DTP group. The second users are other first users within the same DTP group as the DTP user and the first user. In order to transact, the first user and second users send a trust transaction, which is the first type of transaction, to the blockchain network. In step 605, the processor of the first computing device 111 generates a first type of transaction. The first type of transaction includes the wallet address 610a of the first user wallet, the second wallet address 610b of a DTP wallet of the DTP user, the update time 610c defined by an update time for a second type of transaction, and the signature 610d generated using the private key of the first user wallet. In step 615, the processor of the first computing device 111 sends data packet 150, including first type of transaction data, via the transceiver over the communications network 106 to the blockchain network. The first type of transaction data includes the information from the first type of transaction. When the first type of transaction is added to the blockchain, it includes a first time stamp that represents the block creation or mining time. The first time stamp is used as a starting time for the update time specified in the first type of transaction. The update time is calculated to determined how much time the DTP user has to complete the execution of the second transaction. In certain embodiments, when the DTP user fails to execute the second transaction within the update time, then the DTP user is no longer a decentralized trusted party for the users within the DTP group and the said users are disassociated from said DTP group.

Referring now to FIG. 6B, a diagram 601 illustrating steps for a method of executing the first type of transaction is shown, according to an example embodiment. After the first type of transaction is sent to the blockchain network, the blockchain network cancels 620a prior wallet authorizations to prior DTP users and grants 620b a wallet authorization to the DTP user to transact the user wallet upon the execution of the second type of transaction. Prior wallet authorizations to prior DTP groups is defined by when a user was previously in another DTP group. The blockchain protocols prohibits 620c the private key of the first user wallet from generating a block signature for any type of transaction other than a second first type of transaction and the third type of transaction in the DTP group. In order for the granting of the wallet authorization and cancelling of prior wallet authorizations to be executed, the first type of transaction is added to the blockchain-network and one of the following occurs: a prior DTP user, authorized to transact the user wallet based on a prior first type of transaction, executes 625 the second type of transaction, the prior DTP user fails to execute 630 the second type of transaction within the update time of the prior first type of transaction, and the blockchain network determines 635 that the wallet address of the user wallet is not associated with any prior first types of transactions. Determining 625 that the wallet address of the user wallet is not associated with any prior first types of transactions includes determining 640a that the user has never generated nor executed the first type of transaction and determining 640b that the wallet address of the user wallet has generated the first type of transaction and has not generated the third type of transaction. If determining steps 635 through 640b return true, then the DTP user will consider the first user to be in the DTP group and may perform transactions on behalf of the first user via the second type of transaction.

In certain embodiments, when the user executes a first type of transaction, the trust transaction, then it is understood that the user cannot be added to the DTP group of the DTP user until the user is removed from any prior DTP groups associated with the prior DTP users which may require the prior DTP user to execute the second type of transaction. The methods herein described are performed sequentially to eliminate cross-DTP update transactions resulting in improper update balances.

The present disclosure provides two ways to preserve the cryptocurrency in the system and prevent loss. The transactions are set to expire within a predefined number of blocks from the moment of their creation (ideally, 6 blocks). This helps to keep the queue of transactions small and prevents unexpected transaction execution. The predefined expiration also helps to reduce the block size as there is no need to provide a transaction serial number. The transactions of the last blocks are locally saved and cannot be executed more than once. Every few years (ideally, 3 years), all the first users who did not make any transaction to any DTP group will result in their user wallets to be considered as lost, and their total balance will be added toward the blockchain reward system. Therefore, even if a first user lost their private key to the first user wallet including coins, those coins will not be lost, and the circulation will not be affected.

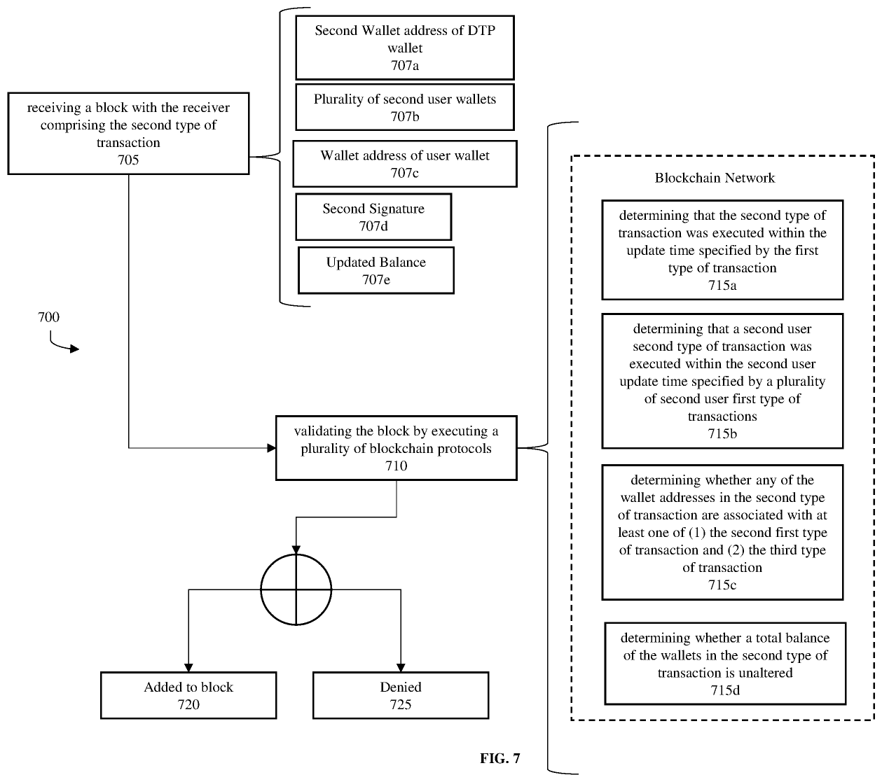

Referring now to FIG. 7, a diagram 700 illustrating steps for a method of executing a second type of transaction is shown, according to an example embodiment. The DTP user generates the second type of transaction after performing transactions on behalf of the first user and the second users. The DTP user sends data packet 154, including the second type of transaction data, over network 106. In step 705, the first computing device receives, with the transceiver, the second type of transaction data via data packet 152 from the communications network 106. Each of the second computing devices, which are associated with the plurality of second users, within the same DTP group as the DTP user and the first user, may also receive, with the transceiver, the second type of transaction data via data packet 160 from the communications network 106. The second type of transaction data includes the second wallet address 707a of the DTP wallet of the DTP user, a plurality of second user wallets 707b associated with the plurality of second users, the wallet address 707c of the user wallet associated with the first user, an updated balance 707d for each wallet address in the second type of transaction, and a second signature 707e generated using the second private key of the DTP wallet of the DTP user. The second type of transaction data may also include a second time stamp that is generated when the block including the second type of transaction is validated using the blockchain protocols as further described below. The second type of transaction may also include transaction fees accumulated in the update transaction.

In step 710, after receiving the block, the computing devices validate the block by executing a plurality of blockchain protocols. The blockchain protocols includes determining 715a that the second type of transaction was executed within the update time specified by the first type of transaction and determining 715b that a second user second type of transaction was executed within the second user update time specified by a plurality of second user first type of transactions. The second time stamp allows the blockchain protocol to determine whether the second type of transaction is executed within the update time. If the second time stamp is within the addition of the update time to the first time stamp, steps 715a and 715b return true. If the second time stamp is not within said addition, then steps 715a and 715b return false. Step 715a checks the period of time for the first user, and step 715b checks the period of time for the second users. The blockchain protocols also include determining 715c whether any of the wallet addresses in the second type of transaction are associated with at least one of the second first type of transaction and the third type of transaction. The blockchain protocols also include determining 715d whether a total balance of the wallets in the second type of transaction is unaltered. The total balance of the wallets is unaltered if the total number of coins is the same as the total number of coins prior to the transaction. If the determining steps 715a through 715d are successful and determined to be true, then the block is validated. In step 720, if the block is validated, then the block is added to the blockchain, and the first computing device adds the block to a local blockchain of the first computing device. Once the block including the second type of transaction is validated and added to the blockchain, the update time restarts. In step 725, if the block is not validated, then the block is denied.

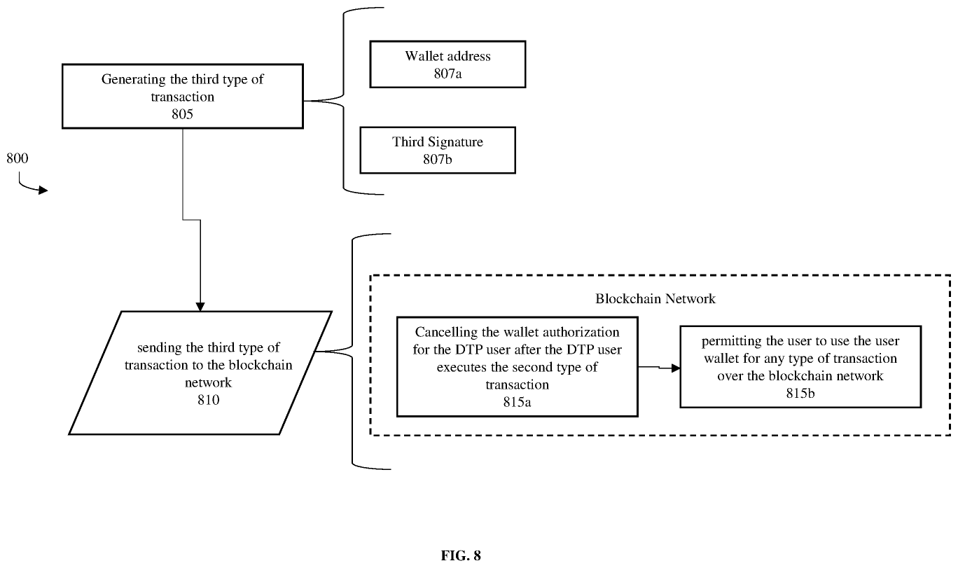

Referring now to FIG. 8, a diagram 800 illustrating steps for a method of executing the third type of transaction is shown, according to an example embodiment. When the first user decides to regain its wallet access, the first user sends a termination transaction that disables the DTP user's ability to perform transactions on behalf of the first user. The termination transaction removes the first user from the DTP group. In step 805, the processor of the first computing devices generates the third type of transaction. The third type of transaction includes the wallet address 807a of the first user wallet and a third signature 807b generated using the private key of the first user wallet. In step 810, the processor of the first computing device sends data packet 150, including third type of transaction data, via the transceiver over the communications network 106 to the blockchain network to cancel 815a the wallet authorization for the DTP user after the DTP user executes the second type of transaction. After cancelling the wallet authorization, the blockchain network permits 815b the first user to use the first user wallet for any type of transaction over the blockchain network. After the termination transaction is completely executed, the first user is removed from the DTP group.

DTP is fantastic, but it will be infeasible to implement while the block size is limited, no major cryptocurrency is using a block size over 100 MB today.

Pools are peers, they are the core nodes in the Royal Network. Their number is limited to 200, and each of them can have an unlimited amount of wallets connected to it. Each wallet communicates with only one pool, this communication is not happening on the blockchain network, only pools can communicate on the blockchain network to broadcast transactions and blocks. Pool is responsible for the creation of blocks, and broadcasting transactions. Pool maintains a ledger that has all the information of the blockchain, such as wallets balances, Automated Smart Contract and more. The wallet is the client-side program. Its responsible for the creation of wallet public and private keys, making transactions, and mining coins. It communicates with the pool to fetch wallet balance or broadcast a transaction.

The second type transaction can consume a lot of space (3.8 to 11.4 MB for 1,000,000 wallet address as calculated earlier) and there could be multiple second type transactions in a single block. The Royal Network is formed from peers in the last blocks. A peer is a pool who mined/created a block. It's a small, predefined number that allows to use an optimal networking solution, like a direct connection, or a special networking equipment that will be verified by the blockchain protocols. Unlike in today's cryptocurrencies, where special communication equipment is not enforced, peers with 1 Mbit and 2,000 Mbit internet connection can sit on the same network. The most significant benefit of Royal network is the broadcasting speed, the resourcefulness of the peers allows them to use the best technology money can buy and since they use an optimized connection the block size can be dramatically increased.

To join the Royal Network, one need to be able to mine a block and keep mining them, and be resourceful enough to serve all the wallets in the system. This is something that is verified during the join transaction protocol between a wallet and a Pool.

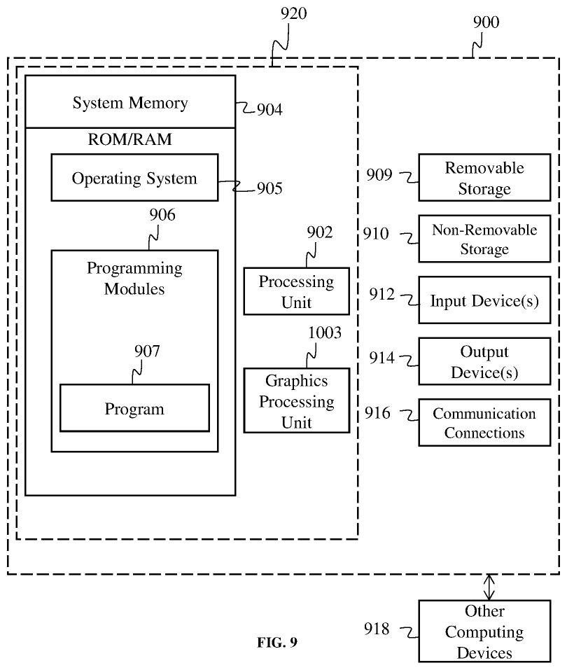

FIG. 9 is a block diagram of a system including an example computing device 900 and other computing devices. Consistent with the embodiments described herein, the aforementioned actions performed by computing devices 111, 121, and 131 may be implemented in a computing device, such as the computing device 900 of FIG. 9. Any suitable combination of hardware, software, or firmware may be used to implement the computing device 900. The aforementioned system, device, and processors are examples and other systems, devices, and processors may comprise the aforementioned computing device. Further-more, computing device 900 may comprise an operating environment for the methods shown in FIGS. 5 through 8 above.

With reference to FIG. 9, a system consistent with an embodiment of the invention may include a plurality of computing devices, such as computing device 900. In a basic configuration, computing device 900 may include at least one processing unit 902 and a system memory 904. Depending on the configuration and type of computing device, system memory 904 may comprise, but is not limited to, volatile (e.g., random access memory (RAM)), nonvolatile (e.g., read-only memory (ROM)), flash memory, or any combination or memory. System memory 904 may include operating system 905, one or more programming modules 906 (such as program module 907). Operating system 905, for example, may be suitable for controlling computing device 900's operation. In one embodiment, programming modules 906 may include, for example, a program module 907. Furthermore, embodiments of the invention may be practiced in conjunction with a graphics library, other operating systems, or any other application program and is not limited to any particular application or system. This basic configuration is illustrated in FIG. 900 by those components within a dashed line 1020.

Computing device 900 may have additional features or functionality. For example, computing device 900 may also include additional data storage devices (removable and/or non-removable) such as, for example, magnetic disks, optical disks, or tape. Such additional storage is illustrated in FIG. 9 by a removable storage 1009 and a non-removable storage 910. Computer storage media may include volatile and nonvolatile, removable, and non-removable media implemented in any method or technology for storage of information, such as computer readable instructions, data structures, program modules, or other data. System memory 904, removable storage 1009, and non-removable storage 910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 900. Any such computer storage media may be part of device 900. Computing device 900 may also have input device(s) 912 such as a keyboard, a mouse, a pen, a sound input device, a camera, a touch input device, etc. Output device(s) 914 such as a display, speakers, a printer, etc. may also be included. The aforementioned devices are only examples, and other devices may be added or substituted.

Computing device 900 may also contain a communication connection 916 that may allow device 900 to communicate with other computing devices 918, such as over a network in a distributed computing environment, for example, an intranet or the Internet. Communication connection 916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acous-tic, radio frequency (RF), infrared, and other wireless media. The term computer readable media as used herein may include both computer storage media and communication media.

As stated above, a number of program modules and data files may be stored in system memory 904, including operating system 905. While executing on processing unit 902, programming modules 906 may perform processes including, for example, one or more of the methods shown in FIGS. 5 through 8 above. Computing device 900 may also include a graphics processing unit 1003, which supplements the processing capabilities of processor 902 and which may execute programming modules 906, including all or a portion of those processes and methods shown in FIGS. 5 through 8 above. The aforementioned processes are examples, and processing units 902, 1003 may perform other processes. Other program-ming modules that may be used in accordance with embodiments of the present invention an may include, for example, electronic mail and contacts applications, word processing applications, spreadsheet applications, database applications, slide presentation applications, drawing or computer aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configura-tions, including handheld devices, multiprocessor systems, microprocessor based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be prac-ticed in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the inven-tion. The functions/acts noted in the blocks may occur out of the order as shown in any flowchart. For example, two blocks shown in succession may in fact be executed substantially concurrently or the blocks may sometimes be executed in the reverse order, depending upon the function-ality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A system for transferring cryptocurrency between a plurality of wallets, without revealing an origin or a destination or an encrypted origin or an encrypted destination, the system comprising:
(A) a communications network;
(B) a blockchain network comprising a plurality of computing devices, wherein each of the plurality of computing devices comprise a processor, a local storage, and a transceiver;
(C) wherein each computing device of the plurality of computing devices corresponds with one of a plurality of users, wherein each computing device of the plurality of computing devices is configured for sending a plurality of types of transactions and receiving a plurality of blocks based on a plurality of blockchain protocols;
(D) wherein the processor and a receiver for each computing device of the plurality of computing devices is configured for:
(1) generating, using the processor of a first computing device of one of the plurality of computing devices, a user wallet, wherein the user wallet comprises a private key and a wallet address;
(2) storing, in the local storage of the first computing device, the user wallet;
(3) validating, with the processor, the plurality of blocks to be added to a blockchain associated with the blockchain network, by executing the plurality of blockchain protocols;
(4) storing, in the local storage of the first computing device, the blockchain comprising the plurality of blocks;
(5) generating, with the processor, a first type of transaction comprising:
(a) the wallet address of the user wallet;
(b) a second wallet address of a DTP wallet of a DTP user;
(c) an update time defined by a predetermined periodic execution for a second type of transaction;
(d) a signature generated using the private key of the user wallet;
(6) sending the first type of transaction over the communications network to the blockchain network to:
(i) cancel prior wallet authorizations to prior DTP users;
(ii) grant a wallet authorization to the DTP user to transact the user wallet upon an execution of the second type of transaction;
(iii) wherein the granting of the wallet authorization and cancelling of prior wallet authorizations is executed when the first type of transaction is added to the blockchain network and one of:
A. a prior DTP user, authorized to transact the user wallet based on a prior first type of transaction, executes the second type of transaction;
B. the prior DTP user fails to execute the second type of transaction within the update time of the prior first type of transaction;
C. determining that the wallet address of the user wallet is not associated with any prior first types of transactions;
(iv) prohibit the private key of the user wallet from generating a block signature for any type of transaction other than a second first type of transaction and a third type of transaction, until the DTP user fails to execute the second type of transaction within the update time;
(7) receiving a block over the communications network with the receiver comprising the second type of transaction, wherein the second type of transaction comprises:
(a) the second wallet address of the DTP wallet of the DTP user;
(b) a plurality of second user wallets associated a plurality of second users;
(c) the wallet address of the user wallet associated with a first user;
(d) an updated balance for each wallet address in the second type of transaction;
(e) a second signature generated using a second private key of the DTP wallet of the DTP user;
(8) after receiving the block, then validating the block by executing the plurality of blockchain protocols comprising:
(a) determining that the second type of transaction was executed within the update time specified by the first type of transaction;
(b) determining that a second user second type of transaction was executed within a second user update time specified by a plurality of second user first type of transactions;
(c) determining whether any of the wallet addresses in the second type of transaction are associated with at least one of (1) the second first type of transaction and (2) the third type of transaction;
(d) determining whether a total balance of the wallets in the second type of transaction is unaltered;
(9) if the block is validated, then, storing the block on the first computing device and adding the block to a local blockchain of the first computing device;
(10) generating, with the processor, the third type of transaction comprising:
(a) the wallet address of the user wallet;
(b) a third signature generated using the private key of the user wallet;
(11) sending the third type of transaction over the communications network to the blockchain network to:
(i) cancel the wallet authorization for the DTP user after the DTP user executes the second type of transaction; and
(ii) after cancelling the wallet authorization, then permitting the first user to use the user wallet for any type of transaction over the blockchain network.

2. The system of claim 1, wherein the predetermined periodic execution is one of (i) a predetermined block count, and (ii) a period of time to complete the second type of transaction, wherein the predetermined periodic execution starts when at least one of (i) the first type of transaction is sent to the blockchain and (ii) the second type of transaction is validated.

3. The system of claim 2, wherein the update time continuously restarts after each second type of transaction is validated and ends when the third type of transaction is added to the blockchain network.

4. The system of claim 3, wherein the updated balance of the second type of transaction is determined based on a plurality of intermittent transactions by the DTP user that were executed off of the blockchain network between the user wallet and at least one second user wallet of the plurality of second user wallets.

5. The system of claim 4, wherein the updated balance of the second type of transaction is determined based on the plurality of intermittent transactions by the DTP user between the user wallet and the at least one second user wallet of the plurality of second user wallets.

6. The system of claim 5, wherein the total balance of all the wallets in the second type of transaction is unaltered such that the total balance in the second type of transaction is equal to a first balance of a plurality of first types of transactions.

7. The system of claim 6, wherein determining that the wallet address of the user wallet is not associated with any prior first types of transactions comprises at least one of:
(1) determining that the first user has never generated the first type of transaction; and
(2) determining that the wallet address of the user wallet has generated the first type of transaction and has not generated the third type of transaction.

8. The system of claim 7, wherein the update time is generated when the DTP wallet is created by the DTP user.

9. A computer implemented method for transferring cryptocurrency between a plurality of wallets, without revealing an origin or a destination or an encrypted origin or an encrypted destination, implementable on a blockchain network comprising a plurality of computing devices, wherein each computing device of the plurality of computing devices corresponds with one of a plurality of users, wherein each computing device of the plurality of computing devices is configured for sending a plurality of types of transactions and receiving a plurality of blocks based on a plurality of blockchain protocols and is configured for sending the plurality of types of transactions and receiving the plurality of blocks based on the plurality of blockchain protocols transmitted across the blockchain network over a communications network, the computer implemented method comprising:
(1) generating, using a processor of a first computing device of one of the plurality of computing devices, a user wallet, wherein the user wallet comprises a private key and a wallet address;
(2) storing, in a local storage of the first computing device, the user wallet;
(3) validating, with the processor, the plurality of blocks to be added to a blockchain associated with the blockchain network, by executing the plurality of blockchain protocols;
(4) storing, in the local storage of the first computing device, the blockchain comprising the plurality of blocks;
(5) generating, with the processor, a first type of transaction comprising:
(a) the wallet address of the user wallet;
(b) a second wallet address of a DTP wallet of a DTP user;
(c) an update time defined by a predetermined periodic execution for a second type of transaction;
(d) a signature generated using the private key of the user wallet;
(6) sending the first type of transaction over the communications network to the blockchain network to:
(i) cancel prior wallet authorizations to prior DTP users;
(ii) grant a wallet authorization to the DTP user to transact the user wallet upon an execution of the second type of transaction;
(iii) wherein the granting of the wallet authorization and cancelling of prior wallet authorizations is executed when the first type of transaction is added to the blockchain network and one of:
D. a prior DTP user, authorized to transact the user wallet based on a prior first type of transaction, executes the second type of transaction;
E. the prior DTP user fails to execute the second type of transaction within the update time of the prior first type of transaction;
F. determining that the wallet address of the user wallet is not associated with any prior first types of transactions;
(iv) prohibit the private key of the user wallet from generating a block signature for any type of transaction other than a second first type of transaction and a third type of transaction, until the DTP user fails to execute the second type of transaction within the update time;
(7) receiving a block over the communications network with a receiver comprising the second type of transaction, wherein the second type of transaction comprises:
(a) the second wallet address of the DTP wallet of the DTP user;
(b) a plurality of second user wallets associated a plurality of second users;
(c) the wallet address of the user wallet associated with a first user;
(d) an updated balance for each wallet address in the second type of transaction;
(e) a second signature generated using a second private key of the DTP wallet of the DTP user;
(8) after receiving the block, then validating the block by executing the plurality of blockchain protocols comprising:
(a) determining that the second type of transaction was executed within the update time specified by the first type of transaction;
(b) determining that a second user second type of transaction was executed within a second user update time specified by a plurality of second user first type of transactions;
(c) determining whether any of the wallet addresses in the second type of transaction are associated with at least one of (1) the second first type of transaction and (2) the third type of transaction;
(d) determining whether a total balance of the wallets in the second type of transaction is unaltered;
(9) if the block is validated, then, storing the block on the first computing device and adding the block to a local blockchain of the first computing device;
(10) generating, with the processor, the third type of transaction comprising:
(a) the wallet address of the user wallet;
(b) a third signature generated using the private key of the user wallet;
(11) sending the third type of transaction over the communications network to the blockchain network to:
(i) cancel the wallet authorization for the DTP user after the DTP user executes the second type of transaction; and
(ii) after cancelling the wallet authorization, then permitting the first user to use the user wallet for any type of transaction over the blockchain network.

10. The computer implemented method of claim 9, wherein the predetermined periodic execution is one of (i) a predetermined block count, and (ii) a period of time to complete the second type of transaction, wherein the predetermined periodic execution starts when at least one of (i) the first type of transaction is sent to the blockchain and (ii) the second type of transaction is validated.

11. The computer implemented method of claim 10, wherein the update time continuously restarts after each second type of transaction is validated and ends when the third type of transaction is added to the blockchain network.

12. The computer implemented method of claim 11, wherein the updated balance of the second type of transaction is determined based on a plurality of intermittent transactions by the DTP user that were executed off of the blockchain network between the user wallet and at least one second user wallet of the plurality of second user wallets.

13. The computer implemented method of claim 12, wherein the updated balance of the second type of transaction is determined based on the plurality of intermittent transactions by the DTP user between the user wallet and the at least one second user wallet of the plurality of second user wallets.

14. The computer implemented method of claim 13, wherein the total balance of all the wallets in the second type of transaction is unaltered such that the total balance in the second type of transaction is equal to a first balance of a plurality of first types of transactions.

15. The computer implemented method of claim 14, wherein determining that the wallet address of the user wallet is not associated with any prior first types of transactions comprises at least one of:
(1) determining that the first user has never generated the first type of transaction; and
(2) determining that the wallet address of the user wallet has generated the first type of transaction and has not generated the third type of transaction.

16. A computer implemented method for transferring cryptocurrency between a plurality of wallets, without revealing an origin or a destination or an encrypted origin or an encrypted destination, implementable on a blockchain network comprising a plurality of computing devices, wherein each computing device of the plurality of computing devices corresponds with one of a plurality of users, wherein each computing device of the plurality of computing devices is configured for sending a plurality of types of transactions and receiving a plurality of blocks based on a plurality of blockchain protocols and is configured for sending the plurality of types of transactions and receiving the plurality of blocks based on the plurality of blockchain protocols transmitted across the blockchain network over a communications network, the computer implemented method comprising:
(1) generating, using a processor of a first computing device of one of the plurality of computing devices, a user wallet, wherein the user wallet comprises a private key and a wallet address;
(2) storing, in a local storage of the first computing device, the user wallet;
(3) validating, with the processor, the plurality of blocks to be added to a blockchain associated with the blockchain network, by executing the plurality of blockchain protocols;
(4) storing, in the local storage of the first computing device, the blockchain comprising the plurality of blocks;
(5) generating, with the processor, a first type of transaction comprising:
(a) the wallet address of the user wallet;
(b) a second wallet address of a DTP wallet of a DTP user;
(c) an update time defined by a predetermined periodic execution for a second type of transaction;
(d) a signature generated using the private key of the user wallet;
(6) sending the first type of transaction over the communications network to the blockchain network to:
(i) cancel prior wallet authorizations to prior DTP users;
(ii) grant a wallet authorization to the DTP user to transact the user wallet upon an execution of the second type of transaction;
(iii) wherein the granting of the wallet authorization and cancelling of prior wallet authorizations is executed when the first type of transaction is added to the blockchain network and one of:
A. a prior DTP user, authorized to transact the user wallet based on a prior first type of transaction, executes the second type of transaction;
B. the prior DTP user fails to execute the second type of transaction within the update time of the prior first type of transaction;
C. determining that the wallet address of the user wallet is not associated with any prior first types of transactions;
(iv) prohibit the private key of the user wallet from generating a block signature for any type of transaction other than a second first type of transaction and a third type of transaction, until the DTP user fails to execute the second type of transaction within the update time;
(7) receiving a block over the communications network with a receiver comprising the second type of transaction, wherein the second type of transaction comprises:
(a) the second wallet address of the DTP wallet of the DTP user;
(b) a plurality of second user wallets associated a plurality of second users;
(c) the wallet address of the user wallet associated with a first user;
(d) an updated balance for each wallet address in the second type of transaction; and
(e) a second signature generated using a second private key of the DTP wallet of the DTP user.

17. The computer implemented method of claim 16 further comprising:
(1) after receiving the block, then validating the block by executing the plurality of blockchain protocols comprising:
(a) determining that the second type of transaction was executed within the update time specified by the first type of transaction;
(b) determining that a second user second type of transaction was executed within a second user update time specified by a plurality of second user first type of transactions;
(c) determining whether any of the wallet addresses in the second type of transaction are associated with at least one of (1) the second first type of transaction and (2) the third type of transaction;
(d) determining whether a total balance of the wallets in the second type of transaction is unaltered; and
(3) if the block is validated, then, storing the block on the first computing device and adding the block to a local blockchain of the first computing device.

18. The computer implemented method of claim 16 further comprising:
(1) generating, with the processor, the third type of transaction comprising:
(a) the wallet address of the user wallet;
(b) a third signature generated using the private key of the user wallet;
(2) sending the third type of transaction over the communications network to the blockchain network to:
(i) cancel the wallet authorization for the DTP user after the DTP user executes the second type of transaction; and
(ii) after cancelling the wallet authorization, then permitting the first user to use the user wallet for any type of transaction over the blockchain network.

19. The computer implemented method of claim 16, wherein the predetermined periodic execution is one of (i) a predetermined block count, and (ii) a period of time to complete the second type of transaction, wherein the predetermined periodic execution starts when at least one of (i) the first type of transaction is sent to the blockchain and (ii) the second type of transaction is validated; and
wherein the update time continuously restarts after each second type of transaction is validated and ends when the third type of transaction is added to the blockchain network.

20. The computer implemented method of claim 16, wherein determining that the wallet address of the user wallet is not associated with any prior first types of transactions comprises at least one of:
(1) determining that the first user has never generated the first type of transaction; and
(2) determining that the wallet address of the user wallet has generated the first type of transaction and has not generated the third type of transaction.
